(19) United States
(12) Patent Application Publication
(10) Pub. No.: US 2004/0252756 A1
(43) Pub. Date: Dec. 16, 2004

(54) Video signal frame rate modifier and method for 3D video applications

(76) Inventors: David Smith, El Dorado Hills, CA (US); Marty M. Holloway, Sacramento, CA (US)

Correspondence Address: M. David Galin, Renner, Otto, Boisselle & Sklar, LLP, Nineteenth Floor, 1621 Euclid Avenue, Cleveland, OH, 44115-2191, US

(21) Appl. No.: 10/457,999

(22) Filed: Jun. 10, 2003

(51) Int. Cl. H04N 7/12

(52) U.S. Cl. 375/240.01; 348/42; 382/285

(57) ABSTRACT

A assembly that modifies the frame rate of a 3D video signal and corresponding method are disclosed. The frame rate of the video signal can be increased by clocking a video encoder at a desired clock rate. When viewing a display of the video signal with the increased frame rate through a pair of stereo glasses, the perception of flicker can be reduced or eliminated.

### TECHNICAL FIELD

The present invention relates generally to the field of three dimensional (3D) imaging and, more particularly, to a video signal frame rate modification system and associated method to reduce the perception of flicker when viewing a 3D video presentation.

### BACKGROUND

In general, an individual uses both eyes to view objects and images. Each eye views these objects and images from a slightly different vantage point due to the separation between the eyes. Depth is perceived by the combination of the images viewed by both eyes by the human brain such that people can view the world in three dimensions. When images are portrayed on a two-dimensional (2D) surface, such as a computer display, television screen or movie screen, both of the viewer's eyes perceive the same image and no depth perception for that image can be perceived.

Sometimes, it may be desirable to portray images to a user of a display device in three dimensions, for instance, to enhance the realism of a computer game, movie, video presentation or other visual information.

Techniques to artificially create a perception of depth on a 2D surface have included the use of presenting different images to the left and right eyes of the viewer. For instance, different images can be presented to each eye by using special glasses. One early system used polarized glasses where the lenses of the glasses passed vertically polarized light to one eye and horizontally polarized light to the other eye. Upon projection of correctly polarized images to a viewed movie screen, for example, or upon the displaying of correctly polarized images on a display, such as a computer display, the viewer would perceive a three-dimensional (3)D image.

More sophisticated systems include using a set of eyeglasses that have a left lens and a right lens, each of which can be placed in an open position or a closed position akin to the opening or closing of a shutter. For instance, the lenses can be made from electronically controllable liquid crystal assemblies. The lenses can be controlled to be alternatively opened and closed (e.g., when the left eye is open allowing the left eye to view the screen, the right eye is closed to prevent the right eye from viewing the screen, and vice-versa). In coordination with the opening and closing of the lenses, images are placed on the screen such that the left eye views one series of images and the right eye views a second, different series of images. Usually images from the respective series are alternately viewed, and the two series of images are combined by the brain in such a way to perceive depth. These glasses are sometimes referred to as shutter glasses or stereo glasses.

There are several standard formats for 3D video signals containing left and right eye images that can be displayed for viewing in conjunction with a pair of stereo glasses. Examples include an interlaced technique, a reversed interlaced technique, a page-flip technique, and an over/under technique. These techniques will generally be known to those in the art and will not be described in great detail.

Many display systems, such as televisions, have a scan rate of 60 Hz (or 50 Hz or other rate as found in some countries other than the United States). That is, sixty times a second a new image is displayed on the display and changes from image to image to present a dynamic video presentation to the viewer (e.g., presents motion to the viewer). Images presented on the display are alternatively deemed odd and even fields. Under the 3D imaging techniques mentioned above, the odd fields are generally presented to one eye of the viewer (e.g., the left eye) and the even fields are generally presented to the other eye of the viewer (e.g., the right eye). As a result, each eye views images about 30 times a second, which is a refresh rate that is slow enough to introduce a noticeable flicker component. Flicker is distracting to most viewers and commonly causes eye strain, each of which could lead to an unpleasant 3D viewing experience.

Accordingly, there exists a need in the art for improved 3D viewing technology that reduces the perception of flicker by the viewer.

### SUMMARY OF THE INVENTION

According to one aspect of the invention, the invention is directed to a video signal frame rate modifying assembly for modifying a frame rate of a native video signal for use in a stereo display system, the native video signal containing alternating left and right eye images. The modifying assembly can include a clock signal generator for generating a clock signal, the clock signal having a frequency of a desired frame rate for an output video signal of the video signal frame rate modifying assembly, and a video encoder for receiving the native video signal and increasing a frame rate of the native video signal to the desired frame rate based on the clock signal, the increased frame rate video signal output as the output video signal.

According to another aspect of the invention, the invention is directed to a two-dimensional (2D) to three-dimensional (3)D video signal transformer assembly. The transformer assembly can include a video decoder for receiving an analog input video signal having a native frame rate and converting the input video signal to a digital video signal at the native frame rate; a video processor for executing logic to convert the decoded video signal from a 2D format to a 3D format and outputting a processed video signal at the native frame rate and having alternating left and right eye images; and a video encoder that is clocked at a multiple of the native frame rate, the video encoder for converting the processed video signal from a digital format to an analog output video signal at the multiplied frame rate.

According to yet another aspect of the invention, the invention is directed to a method of modifying a frame rate of a native video signal for use in a stereo display system, the native video signal containing alternating left and right eye images. The method of modifying can include generating a clock signal having a frequency of a desired frame rate for an output video signal, the output video signal adapted for display by a display assembly, and increasing the frame rate of the native video signal based on the clock signal and outputting the increased frame rate video signal as the output video signal.

According to still another aspect of the invention, the invention is directed to a method of converting a two-dimensional (2D) video signal to a three-dimensional (3)D video signal. The method of converting can include decoding a received analog input video signal having a native frame rate, the decoding including converting the input video signal to a digital video signal at the native frame rate; converting the decoded video signal from a 2D format to a 3D format to generate a processed video signal at the native frame rate and having alternating left and right eye images; and encoding the processed video signal at a multiple of the native frame rate, the encoding converting the processed video signal from a digital format to an analog output video signal at the multiplied frame rate.

According to another aspect of the invention, the invention is directed to a video signal frame rate modifying assembly for modifying a frame rate of a native video signal for use in a stereo display system, the native video signal containing alternating left and right eye images. The assembly can include a video encoder for receiving the native video signal and increasing a frame rate of the native video signal to provide an output video signal, and an input to the video encoder to indicate the increased frame rate.

### BRIEF DESCRIPTION OF DRAWINGS

These and further features of the present invention will be apparent with reference to the following description and drawings, wherein:

FIG. 1 is block diagram of a three-dimensional (3)D video presentation system having a two-dimensional (2D) video signal to 3D video signal transformer assembly that includes a video signal frame rate modification function according to the present invention; and

FIG. 2 is a schematic representation of a mapping of a slower rate video signal to a higher rate video signal.

### DISCLOSURE OF INVENTION

In the detailed description that follows, corresponding components have been given the same reference numerals, regardless of whether they are shown in different embodiments of the present invention. To illustrate the present invention in a clear and concise manner, the drawings may not necessarily be to scale and certain features may be shown in somewhat schematic form.

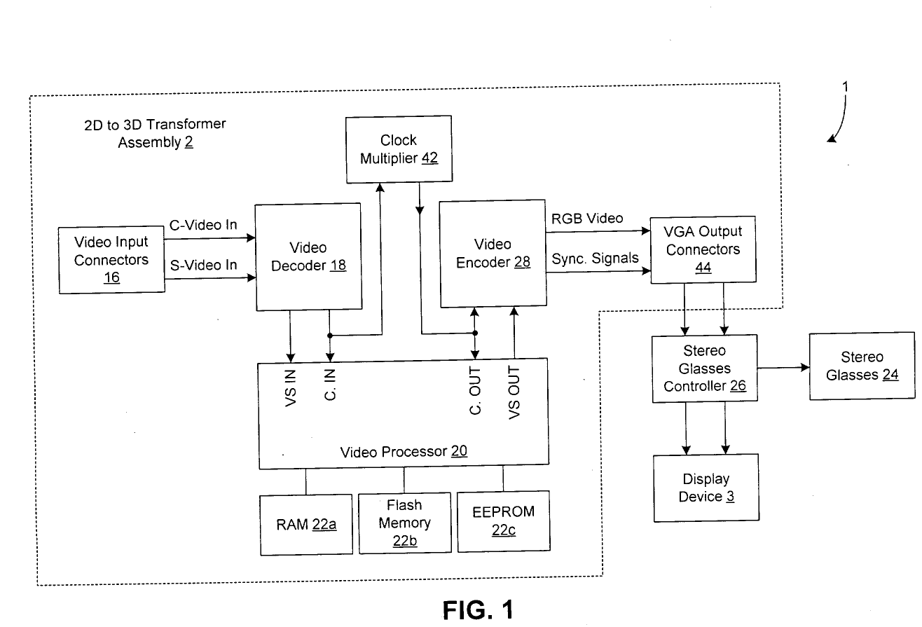

Referring to FIG. 1, shown is a block diagram of a three-dimensional (3)D video presentation system 1. The 3D video presentation system includes a two-dimensional (2D) video signal to 3D video signal transformer assembly 2 that includes a video signal frame rate modification function as will be described in greater detail below. The transformer assembly 2 converts a received 2D video signal (or input video signal) into a 3D output video signal that is output at a frame rate high enough to reduce or eliminate the perception of flicker by a viewer when images corresponding to the 3D output video signal are presented on a display device 3. As used herein, the term video signal relates to any data stream in analog or digital format that includes information regarding a series of images.

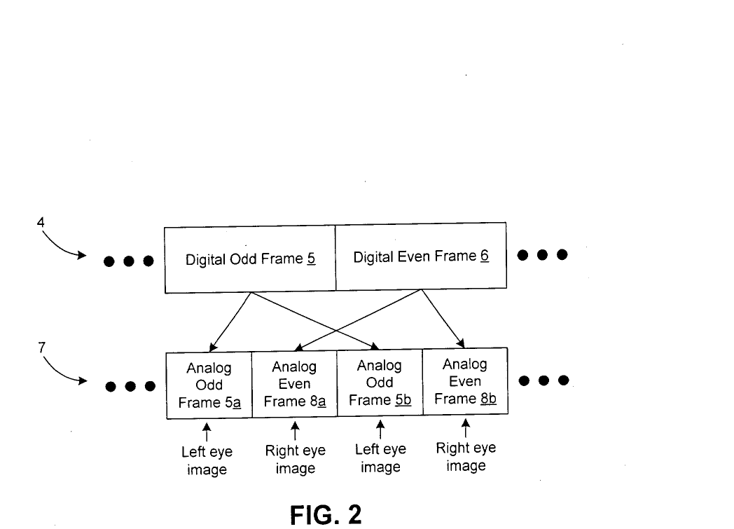

Briefly referring to FIG. 2, an example frame rate modification is shown. A video signal 4 includes data representing a sequence of odd frames 5 and even frames 6 for respective left and right eye (or right and left eye) images to be presented on a display device, such as the display device 3. Also shown in FIG. 2 is a video signal 7 that is prepared according to one embodiment of the invention to modify the frame rate of the video signal 4. In the example of FIG. 2, the frame rate is doubled, but it should be understood that the frame rate can be more or less than doubled. For the doubling example, each frame 5, 6 is doubled to obtain frames 5a, 5b, 8a, 8b, respectively, as at least part of the video signal 7. The video information for frames 5a and 5b may be copies of the video information for frame 5, and the video information for frames 8a and 8b may be copies of the video information for frame 6. The frames 5a, 5b, 8a, 8b are provided in video signal 7 in the sequence illustrated in FIG. 2 (e.g., 5a, 8a, 5b, 8b) and the images represented by those respective frames may be shown by a display device 3. The time it ordinarily takes to display a pair of frames 5, 6 without the doubling on display device 3 can be the same as the time it takes to display all four of the frames 5a, 8a, 5b, 8b. As a result, the effective frame rate of the images shown on the display device 3 is doubled.

Referring back to FIG. 1, the input video signal is received at a video input interface, including, for example, one or more video input connectors 16. For example, standard composite video (“C-video”) connectors and/or standard S-video connectors can be provided for receiving a corresponding video signal format. As should be appreciated, other types of connectors can be provided for receiving alternative video signal formats. The input video signal can originate from a video signal source (not shown), such as a video media playback device (e.g., a video cassette recorder (VCR) or a digital video disk (DVD) player), a video broadcast tuner (e.g., a radio frequency (RF) tuner, a cable signal converter or a satellite receiver), a video game device (e.g., a SONY PLAYSTATION, an X-BOX, etc.), a video camera, a computer executing software to play a stored or downloaded video file or to generate video content, and so forth.

The input video signal received by the video input connectors 16 is fed to a video decoder 18. In one embodiment, the input video signal is received as an analog signal with a frame rate of 60 Hz and is converted by the video decoder 18 to a digital signal. The digital video signal produced by the decoder 18 can be left in the native signal format of the input video signal, or YUV format. Accordingly, the frame rate of the digital video signal output by the decoder 18 can be the same of the input video signal, such as the example 60 Hz. The video decoder 18 can be implemented using a SAA7113 video decoder chip available from Philips Semiconductor of Eindhoven, The Netherlands.

The digital video signal output by the decoder 18 can be fed to a digital video input port (VS IN) of a video processor 20. The video processor 20 can execute logic (e.g., in the form of computer code, or software) to manipulate and otherwise process the digital video signal received from the decoder 18. A wide variety of complex processing functions can be carried out by the video processor 20 on the video signal and, therefore, the video processor 20 can be implemented with a relatively powerful microprocessor assembly, such as a NEXPERIA PNX130x available from Philips Semiconductor. The video processor can be associated with one or more memory components 22 for supporting operation of the video processor 20 and/or for storing executable code, as is well known in the computing arts. Example memory components 22 can include a random access memory (RAM) 22a, a flash memory 22b and an EEPROM 22c. A local interface (not shown), such as a bus or network, can be used to establish operational connectivity among the video processor 20 and the memory components 22.

Example functions that can be carried out by the video processor 20 include various types of data manipulations to convert the video signal from representing a 2D series of images to representing a 3D series of images. For example, the video processor 20 may take several fields of 2D video data and perform mathematical computations to create objects and offsets to achieve a simulated 3D effect by establishing left eye and right eye views of the video content contained by the video signal.

In addition, the data contained by the video signal can be converted into one of several standard formats for coordinating the display of images for three-dimensional viewing using stereo glasses. Example formats include a page-flip technique, an interlaced technique, a reversed interlaced technique, and an over/under technique. As should be understood, the present invention is applicable to other approaches or formats not specifically identified or explained in detail herein. The page-flip technique involves formatting the video data such that left eye images and right eye images are alternatively displaying on the display 3. In coordination with the display of the left and right eye images, left and right lens of a pair of stereo glasses 24 are opened and closed under the control of a stereo glasses controller 26.

The interlaced technique involves formatting the video data such that right eye images are displayed using even lines of the display 3 and left eye images are displayed using odd lines of the display 3. The video signal is filtered to display only even lines or odd lines in synchronization with the opening and closing of the lenses of the stereo glasses 24 such that the left and right eyes view images intended for the appropriate eye. It should be understood that this interlaced technique is more accurately described as a pseudo-interlaced technique since the display is not operating in true interlaced mode, but the display 3 receives data for odd and even rows at different times.

Additional processing to format the video signal for 3D viewing can include, for example, line doubling, reformatting three dimensional video sequences for use by a LCD projector, changing the timing of NTSC signals so that successive fields will write to the same line as well as other processing that would enhance or enable three dimensional viewing of a video signal. The video processor 20 can also be used to add a color code or bar code to the video signal to tag the signal or a portion thereof as containing three dimensional video sequences. This code can be detected by the stereo glasses controller 26, and upon such detection, the stereo glasses 24 can be turned on to facilitate 3D viewing (e.g., open and closed the shutter lens in coordination with the video signal). At the end of the display of 3D video content, another code can be added to the video signal to instruct the stereo glasses controller 26 to return the stereo glasses 24 to a 2D viewing mode (e.g., open both lens so that both the left and right eyes of the viewer can see the display 3).

Additional functions carried out by the video processor 20 can include resizing or re-scaling of a video image, such as from VGA to SVGA or from D1 to QSIF. The video processor 20 can also be used to increase or decrease the resolution of video data. The various functions performed by the video processor 20 can be conducted in real time (e.g., as the video signal is input to the video processor 20) or in a background mode that is not simultaneous with the input of video data. As should be appreciated, additional functions not explicitly specified herein can be performed by the video processor 20.

In addition to the decoded input video signal received by video processor 20 from the decoder 18, a clock signal is received at a video clock input (C. IN) of the video processor 20. The clock signal is passed from the decoder 18 to the video processor 20 and is synchronized with the frame rate of the video signal. Therefore, if the video signal has a frame rate of 60 Hz, the clock will have a frequency of 60 Hz. The clock signal may be used by the video processor to assist in carrying out the various processing functions performed on the video signal.

After the decoded video signal has been processed by the video processor 20, the processed video signal can be output by the video processor 20 at a digital video output port (VS OUT). The processed video signal output by the video processor 20 can remain in digital YUV form and can be applied to an input of a video encoder 28. The video signal applied to the video encoder is also referred to herein as a native video signal, which is associated with a native frame rate (e.g., the frame rate of the input video signal received by the 2D to 3D transformer assembly).

The video encoder 28 encodes the native video signal into a format for display by the display device 3. For example, the video encoder 28 converts the processed video signal into an output video signal of the 2D to 3D transformer assembly 2. For example, the output video signal can be an analog RGB video signal. In one embodiment, the video encoder 28 can be implemented with an SAA7128 encoder chip or an SAA7129 encoder chip, each of which are available from Philips Semiconductor.

The video encoder 28 can be implemented to generate the output video signal having a frame rate that is a multiple of the frame rate of the input video signal received by the decoder 18. In one example, the frame rate is multiplied by a factor of two, resulting in an output frame rate that is twice the incoming frame rate. Other example multiplication factors can include 1.5, 3.0, 4.0 and so forth.

With additional reference to FIG. 2, the frame rate is effectively multiplied by using the video encoder 28 to convert the digital video signal 4 output by the video processor 20 into the analog output signal 7 at the desired frame rate. For example, assuming that the desired frame rate is twice the input frame rate, for each digital odd frame 5 input to the encoder 28, two corresponding analog odd frames 5a and 5b are generated and buffered by a buffer component of the encoder 28. Similarly, for each digital even frame 6 input to the encoder 28, two corresponding analog even frames 8a and 8b are generated and buffered by the buffer component of the encoder 28. This buffering technique can be referred to as double-buffering. The odd frames 5 and the even frames 8 are then alternatively removed from the buffers such that the output signal contains alternating odd and even images at twice the input refresh rate. If the input refresh rate was 60 Hz, the output refresh rate will be 120 Hz. The stereo glasses 24 can then be controlled to allow the left eye of a viewer to view the odd frames 5 and to allow the right eye of the viewer to view the even frames 8. As a result, each eye of the viewer is presented with an image sixty times a second. Without intending to be bound by theory, the presentation of images to each eye of a viewer in this manner will significantly reduce or eliminate the perception of flicker in the 3D video presentation. Although the left eye of the viewer will see the same left eye image twice and the right eye will see the same right eye image twice for each pair of add and even frames of the input video signal, the series of images will be integrated by the viewer's visual perception into a smooth video presentation.

With continued reference to FIG. 1, increasing the refresh frequency of the output video signal relative to the input video signal can be accomplished by clocking the video encoder 28 at the desired rate. The clocked rate controls that rate at which the video encoder 28 carries out digital to analog conversion of the processed video signal. In the illustrated embodiment, a clock multiplier 42 is used to generate an appropriate clock signal for the video encoder 28. The clock multiplier 42 can be configured to receive the clock signal output by the video decoder 18, increase the clock signal output by the video decoder 18 by a desired multiplication factor, and output the multiplied clock signal. The multiplied clock signal is applied to the video encoder for use in converting the processed video signal output by the video processor 20 into the output video signal of the 2D to 3D transformer assembly 2. The multiplied clock signal also can be applied to an output clock signal port (C. OUT) of the video processor 20 to assist in synchronizing video signal transfer between the video processor 20 and the video encoder 28. In one embodiment, the clock multiplier can be implemented with a high-speed, zero delay, phase-lock loop (PLL) clock multiplier, such as an IDT2308 chip available from Integrated Device Technology, Inc. of Santa Clara, Calif.

The analog output video signal generated by the video encoder 28 can be output through an output interface, such as a set of standard VGA output connectors 44 for delivery to the display device 3. As one skilled in the art should appreciate, the display device 3 should be a display device 3 capable of receiving and displaying a video signal having a refresh rate of the output video signal 7. For instance, many computer monitors are capable of displaying video images at a refresh corresponding to the example output refresh rate of 120 Hz. In addition, some televisions and/or projector devices are capable of accepting a video signal with a scan rate higher than the NTSC 60 Hz standard.

In the illustrated example, the video encoder 28 can be configured to output synchronization signals along with the output video signal. For example, in the embodiment where the video output signal is an RGB video signal compatible with the VGA or SVGA standard, appropriate horizontal and vertical synchronization signals can be generated and output by the video encoder 28. Any S-video signal and composite video signal generation capability of the video encoder 28 can be turned off when the video encoder 28 is used to modify the frame rate of the input video signal.

In one embodiment, the video signal input to the 2D to 3D transformer assembly 2 is a 60 Hz NTSC formatted 2D video signal that is converted to 3D video data and output from the 2D to 3D transformer assembly 2 as a 3D RGB signal at twice the incoming frame rate, or 120 Hz. In this process, each left eye image (or odd frame) and each right eye image (or even frame) of the incoming video signal is presented twice in alternating fashion in the output video signal. As should be appreciated, the technique described herein can be applied to other video standards. For example, the 2D to 3D transformer assembly 2 can be configured to receive a 50 Hz PAL formatted 2D video signal and convert that video signal to a 3D video signal at 100 Hz, or other appropriate frame rate.

As should be appreciated, no interpolation of the left and right eye images (e.g., odd and even fields) is carried out by the 2D to 3D transformer assembly 2 when increasing the frame rate of the video signal. Accordingly, image quality can be maintained at the level of the input 2D video signal. In addition, the increase in frame rate is carried out in a system that converts an analog input signal to a digital signal and back to an analog signal only once. As a result, losses in image quality through multiple digital domain to analog domain and analog domain to digital domain conversions can be avoided. Also, the output video stream of the 2D to 3D transformer assembly 2 is phased locked to the input video stream.

Although particular embodiments of the invention have been described in detail, it is understood that the invention is not limited correspondingly in scope, but includes all changes, modifications and equivalents coming within the spirit and terms of the claims appended hereto.

For example, increasing the frame rate can be accomplished by a device that is not associated with the 2D to 3D conversion apparatus. In this alternative, a 3D video signal (e.g., a video signal that already includes left eye and right eye images) can be received by a frame rate increasing device, which acts upon the video signal to increase the frame rate to a desired frequency. In one example configuration, the 2D to 3D conversion apparatus could be a computing device that converts a 2D video signal to a 3D video file that is stored on a memory component. Thereafter, the 3D video file is read from the memory component and output by the computing device as a 3D video signal at the native frame rate (e.g., the frame rate of the 2D video signal). Thereafter, a frame rate modification device can be used to increase the frame rate of the 3D video signal prior to display on a display device.

What is claimed is:

1. A video signal frame rate modifying assembly for modifying a frame rate of a native video signal for use in a stereo display system, the native video signal containing alternating left and right eye images, comprising:
a clock signal generator for generating a clock signal, the clock signal having a frequency of a desired frame rate for an output video signal of the video signal frame rate modifying assembly; and
a video encoder for receiving the native video signal and increasing a frame rate of the native video signal to the desired frame rate based on the clock signal, the increased frame rate video signal output as the output video signal.

2. The video signal frame rate modifying assembly according to claim 1, wherein the video encoder converts the native video signal from a digital signal to an analog signal.

3. The video signal frame rate modifying assembly according to claim 2, wherein the conversion from digital to analog is carried out at the frequency of the clock signal.

4. The video signal frame rate modifying assembly according to claim 3, wherein:
for each left eye image of the native video signal, the video encoder buffers two output left eye frames;
for each right eye image of the native video signal, the video encoder buffers two output right eye frames; and
the buffered left and right eye frames are output in alternating fashion as the output video signal.

5. The video signal frame rate modifying assembly according to claim 1, wherein:
for each left eye image of the native video signal, the video encoder buffers two output left eye frames;
for each right eye image of the native video signal, the video encoder buffers two output right eye frames; and
the buffered left and right eye frames are output in alternating fashion as the output video signal.

6. The video signal frame rate modifying assembly according to claim 1, wherein the clock signal generated by the clock signal generator is phase-locked to a clock signal associated with the native video signal.

7. The video signal frame rate modifying assembly according to claim 1, wherein the clock signal generator is a clock multiplier configured to increase a clock signal associated with the native video signal by a factor of two.

8. A two-dimensional (2D) to three-dimensional (3)D video signal transformer assembly, comprising:
a video decoder for receiving an analog input video signal having a native frame rate and converting the input video signal to a digital video signal at the native frame rate;
a video processor for executing logic to convert the decoded video signal from a 2D format to a 3D format and outputting a processed video signal at the native frame rate and having alternating left and right eye images; and
a video encoder that is clocked at a multiple of the native frame rate, the video encoder for converting the processed video signal from a digital format to an analog output video signal at the multiplied frame rate.

9. The 2D to 3D video signal transformer assembly according to claim 8, wherein:
for each left eye image of the processed video signal, the video encoder buffers two output left eye frames;
for each right eye image of the processed video signal, the video encoder buffers two output right eye frames; and
the buffered left and right eye frames are output in alternating fashion as the output video signal.

10. The 2D to 3D video signal transformer assembly according to claim 8, further comprising a clock multiplier for increasing a clock signal associated with the native video signal to generate a clock signal used to clock the video encoder.

11. The 2D to 3D video signal transformer assembly according to claim 10, wherein the clock signal associated with the native video signal is increased by a factor of two.

12. A method of modifying a frame rate of a native video signal for use in a stereo display system, the native video signal containing alternating left and right eye images, comprising:
generating a clock signal having a frequency of a desired frame rate for an output video signal, the output video signal adapted for display by a display assembly; and
increasing the frame rate of the native video signal based on the clock signal and outputting the increased frame rate video signal as the output video signal.

13. The method according to claim 12, further comprising converting the native video signal from a digital signal to an analog signal.

14. The method according to claim 13, wherein the conversion from digital to analog is carried out at a frequency of the clock signal.

15. The method according to claim 14, further comprising:
buffering two output left eye frames for each left eye image of the native video signal;
buffering two output right eye frames for each right eye image of the native video signal; and
outputting the buffered left and right eye frames in alternating fashion as the output video signal.

16. The method according to claim 12, further comprising:
buffering two output left eye frames for each left eye image of the native video signal;
buffering two output right eye frames for each right eye image of the native video signal; and
outputting the buffered left and right eye frames in alternating fashion as the output video signal.

17. The method according to claim 12, wherein the generated clock signal is phase-locked to a clock signal associated with the native video signal.

18. The method according to claim 12, wherein the frame rate of the output video signal is twice the frame rate of the native video signal.

19. A method of converting a two-dimensional (2D) video signal to a three-dimensional (3)D video signal, comprising:
decoding a received analog input video signal having a native frame rate, the decoding including converting the input video signal to a digital video signal at the native frame rate;
converting the decoded video signal from a 2D format to a 3D format to generate a processed video signal at the native frame rate and having alternating left and right eye images; and
encoding the processed video signal at a multiple of the native frame rate, the encoding converting the processed video signal from a digital format to an analog output video signal at the multiplied frame rate.

20. The method according to claim 19, further comprising:
buffering two output left eye frames for each left eye image of the processed video signal;
buffering two output right eye frames for each right eye image of the processed video signal; and
outputting the buffered left and right eye frames in alternating fashion as the output video signal.

21. The method according to claim 19, further comprising generating a clock signal for driving the encoding by increasing a frequency of a clock signal associated with the native video signal.

22. The method according to claim 19, wherein the output video signal has a frame rate that is twice the frame rate of the input video signal.

23. A video signal frame rate modifying assembly for modifying a frame rate of a native video signal for use in a stereo display system, the native video signal containing alternating left and right eye images, comprising a video encoder for receiving the native video signal and increasing a frame rate of the native video signal to provide an output video signal, and an input to the video encoder to indicate the increased frame rate.
